(19) United States
(12) Patent Application Publication
(10) Pub. No.: US 2024/0125509 A1
(43) Pub. Date: Apr. 18, 2024

(54) High Speed Abort Gate

(71) Applicant: Imperial Systems, Inc., Mercer, PA (US)

(72) Inventors: Jeremiah Wann, Mercer, PA (US); Nick Long, Mercer, PA (US)

(73) Assignee: Imperial Systems, Inc., Mercer, PA (US)

(21) Appl. No.: 18/488,704

(22) Filed: Oct. 17, 2023

Related U.S. Application Data
(60) Provisional application No. 63/379,871, filed on Oct. 17, 2022.

(51) Int. Cl. F24F 13/14; B08B 15/02

(52) U.S. Cl. CPC F24F 13/1426; B08B 15/023; F24F 2013/1453

(57) ABSTRACT

An abort gate to divert airflow in an air system comprises a housing having a flow inlet, a primary outlet, and a secondary outlet. A flow diverting blade is mounted to a shaft within said housing. Rotating a blade arming bar also rotates the flow diverting blade within said housing between a first position and a second position. A pulley bar mounted to the shaft adjacent to the blade arming bar comprises a pulley bar pulley that receives a cable that connects said pulley bar to a winch and a tab on the pulley bar that extends towards the blade arming bar, such that rotation of the pulley bar toward the blade arming bar causes the tab to push said blade arming bar and also rotate the blade arming bar thereby rotating said flow diverting blade.

### BACKGROUND

Abort gates are safety devices used in air systems to divert smoke, fire, sparks, dust, or other hazardous materials that have entered the air system to a safe location. Abort gates are integrated into the ducting of the air system and can quickly actuate to divert the flow from the traditional duct path. For example, fume hoods that extract and filter harmful welding fumes from a workspace may also draw sparks from the welding process into the air extraction system connected to an air system. These sparks could travel into the air extractor's bag house or filter system and cause a fire. When sparks are detected in the air system, the abort gate can quickly actuate to divert the sparks out of the air system so that they are unable to reach the air extractor's bag house.

Abort gates must be armed before use and require an actuation system to set them in the armed position. Small gates can be manually armed, but larger, heavier gates require a mechanical actuation system. Traditionally, linear actuators have been used to arm larger abort gates. However, actuation of heavier gates requires extremely robust, expensive linear actuators to rotate the gate into the armed position with sufficient speed. These robust linear actuators are not readily available, are difficult to service, are frequently integrated with poor quality limit switches, have limited stroke length, and offer no significant mechanical advantage in arming the gate. The cost of these large linear actuators is compounded by the powerful electronics required to control them.

What is presented is an abort gate system that offers greater arming strength and speed than traditional actuation methods, while using cheaper and more readily available components.

### SUMMARY

An abort gate to divert airflow in an air system comprises a housing comprising a flow inlet from the air system, a primary outlet to the air system, and a secondary outlet to a safe flow diversion region. A flow diverting blade is mounted to a shaft within the housing. A blade arming bar is fixed to the shaft such that rotating the blade arming bar also rotates the flow diverting blade within the housing between a first position and a second position. When the flow diverting blade is in the first position, the flow diverting blade seals the primary outlet and flow though the housing is diverted from the flow inlet through the secondary outlet. When the flow diverting blade is in the second position, the flow diverting blade seals the secondary outlet and flow through the housing is diverted from the flow inlet though the primary outlet.

A pulley bar mounted to the shaft is located adjacent to the blade arming bar. The pulley bar comprises a pulley bar pulley that receives a cable that connects the pulley bar to a winch. A tab on the pulley bar extends towards the blade arming bar, such that rotation of the pulley bar toward the blade arming bar causes the tab to push the blade arming bar and also rotate the blade arming bar thereby rotating the flow diverting blade. In some embodiments, a pulley bar spring extends between the housing and the pulley bar to bias the pulley bar away from the blade arming bar.

In some embodiments, when the abort gate is armed, the flow diverting blade is releasably fixed against the second position with one of electromagnets, latches, and pins. In some embodiments, sensors may be mounted upstream from the flow diverting blade to disarm the abort gate and release the flow diverting blade from the second position thereby allowing the flow diverting blade to move into the first position. In some embodiments, a spring mounted to the blade arming bar biases the flow diverting blade in the first position. In some embodiments, the flow diverting blade is biased in the first position by gravity.

In various embodiments, the position of the flow diverting blade is determined by one of limit switches and proximity sensors. In some embodiments, a limit switch is located at the second position such that movement of the flow diverter gate to the second position actuates the winch to move the pulley bar such that the tab is not in contact with the blade arming bar.

In some embodiments, the pully bar has a default position where if the blade arming bar were in the first position, that the tab is not contact with the blade arming bar. In some embodiments, a limit switch is located at the default position that stops the operation of the winch when the pully bar reaches the default position.

In some embodiments, a second pully is fixed to the housing interposed on the cable between the winch and the pulley bar pully. In some embodiments, the cable runs from the winch through the second pully then through the pully bar pully, and is then fixed to the housing, such that actuation of the winch moves said pully bar pully and rotates said pulley bar.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF THE DRAWINGS

For a more complete understanding and appreciation of this invention, and its many advantages, reference will be made to the following detailed description taken in conjunction with the accompanying drawings.

FIG. 1 is a view of a preferred embodiment of a high speed abort gate;

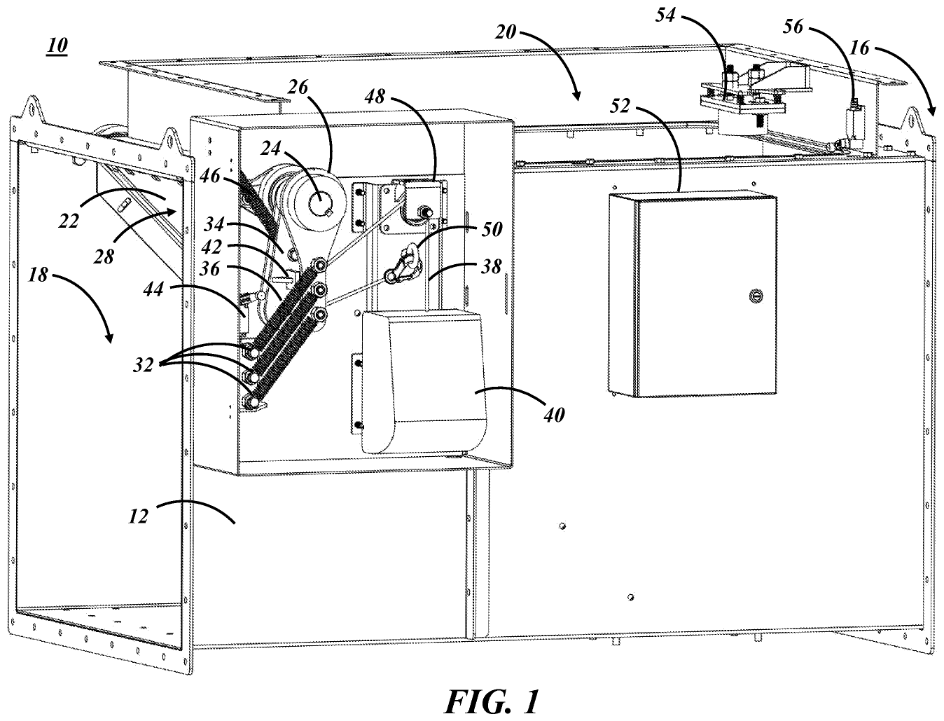

FIG. 2 is a side view of the high speed abort gate of FIG. 1 installed in an air system, showing air flow through the system in the disarmed state;

FIG. 3 is another view of the high speed abort gate of FIG. 2; and

FIG. 4 shows the high speed abort gate of FIG. 1 in the armed state showing air flow through the system.

### DETAILED DESCRIPTION

Referring to the drawings, some of the reference numerals are used to designate the same or corresponding parts through several of the embodiments and figures shown and described. Variations of corresponding parts in form or function that are depicted in the figures are described. It will be understood that variations in the embodiments can generally be interchanged without deviating from the invention.

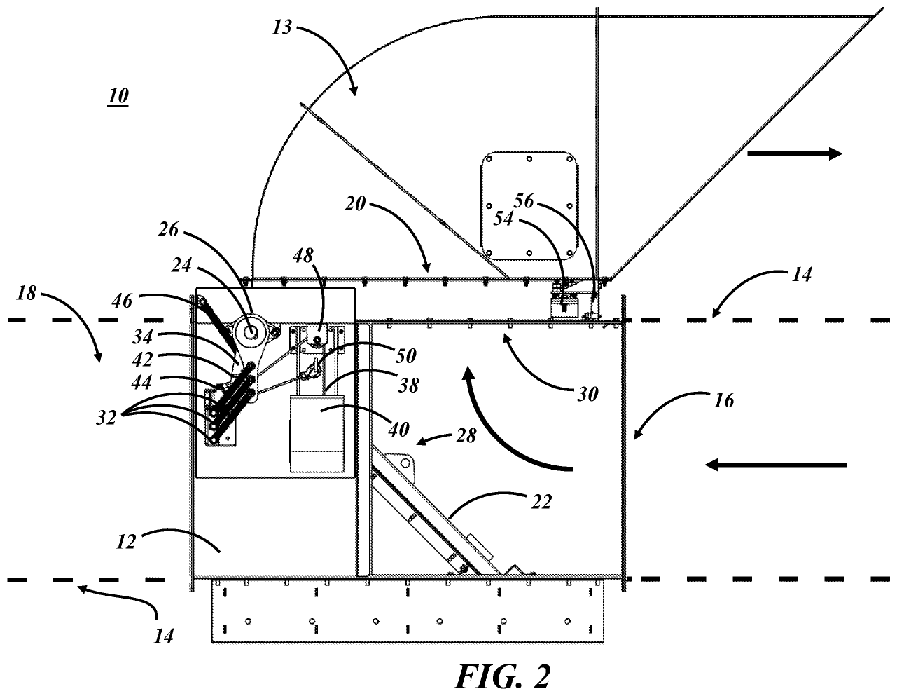

As shown in the figures, an abort gate 10, as disclosed herein, is used to divert airflow in an air system to divert smoke, fire, sparks, dust, fumes, or other hazardous materials that have entered the air system to a safe location. Air systems include ventilation and exhaust systems that are mounted to serve in areas where manufacturing, industrial, and commercial operations occur, such as welding, metal forming, chemical handling, etc. The abort gate 10 comprises a housing 12 installed in ducts 14 (indicated in dotted lines in FIGS. 2-4) in the air system. The housing 12 comprising a flow inlet 16 from the air system, a primary outlet 18 to the air system, and a secondary outlet 20 to a safe flow diversion region 13. In FIG. 2, the diversion 13 is a duct that further directs the flow away from the system, but it could be just to atmosphere. As shown in FIGS. 2-4, a flow diverting blade 22 is mounted to a shaft 24 within the housing 12. A blade arming bar 26 is fixed to the shaft 24 such that rotating the blade arming bar 26 also rotates the flow diverting blade 22 within the housing 12 between a first position 28 and a second position 30.

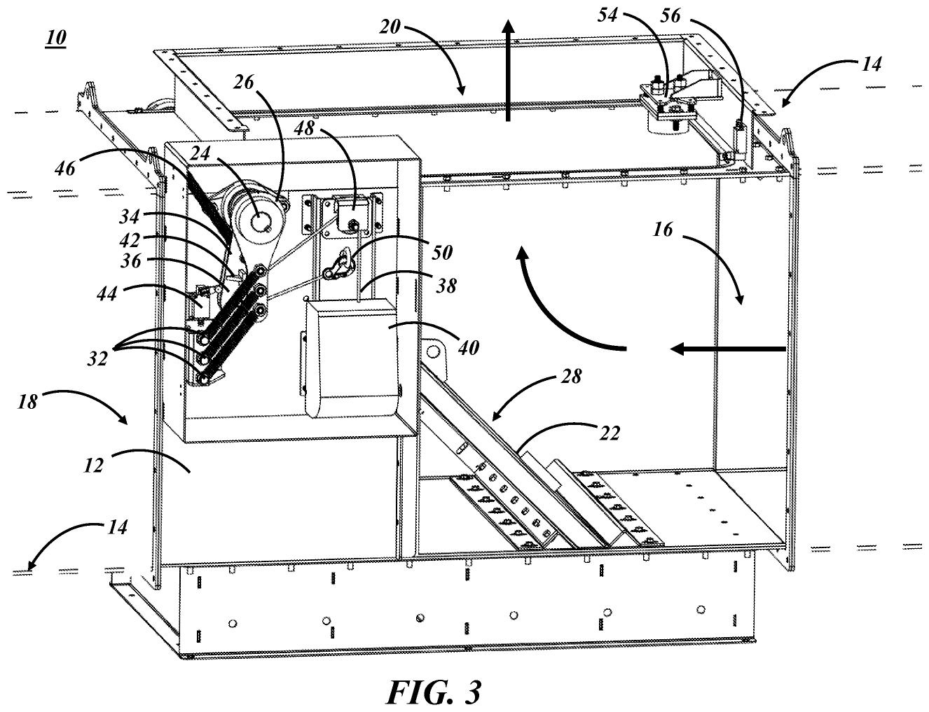

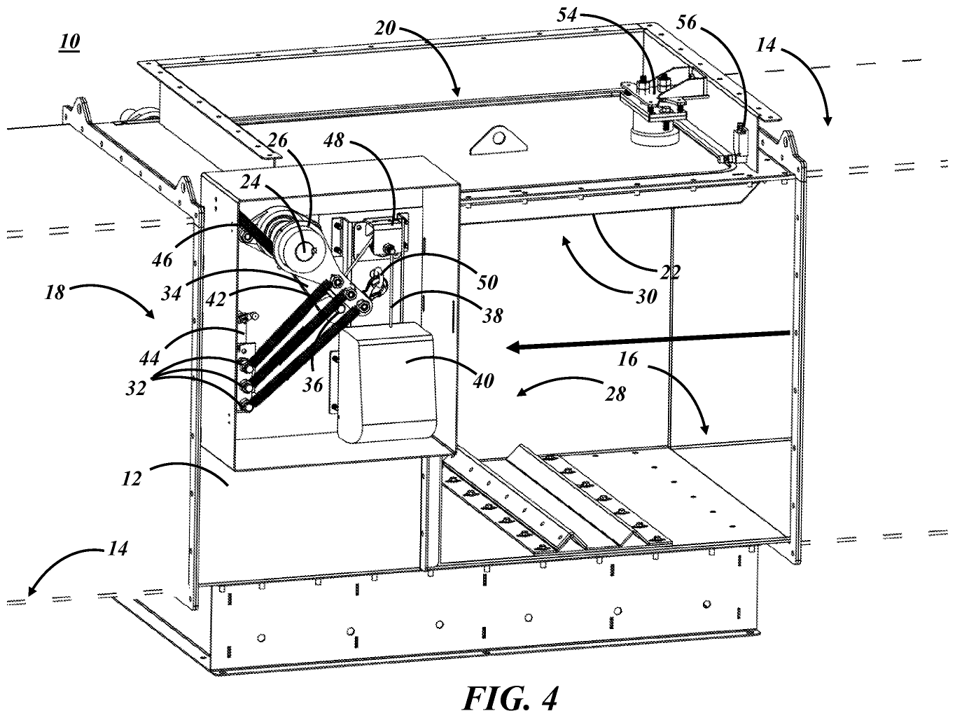

The flow diverting blade 22 is sized and shaped to seal the primary outlet 18 and the secondary outlet 20. As shown in FIGS. 2 and 3, when the flow diverting blade 22 is in the first position 28, the flow diverting blade 22 seals the primary outlet 18 and flow though the housing 12 is diverted from the flow inlet 16 through the secondary outlet 20. As shown in FIG. 4, when the flow diverting blade 22 is in the second position 30, the flow diverting blade 22 seals the secondary outlet 20 and flow through the housing 12 is diverted from the flow inlet 16 though the primary outlet 18. A compressible sealing material such as a rubber gasket (not shown) may line the perimeter of the flow diverting blade 18 or the area of the housing 12 that is contacted by the flow diverting blade 18 at the primary outlet 18 and the secondary outlet 20 to ensure an air-tight seal.

The flow diverting blade 18 is biased against the first position 28 as its default, unarmed condition. This is a safety feature that ensures that if there if there is a power loss in the system, that the air flowing through the air system is diverted to the safe flow diversion region through the secondary outlet 20. When the air system is operating normally, the abort gate 10 is armed, the flow diverting blade 18 is releasably fixed against the second position 30 which allows airflow through the air system.

Rotating the blade arming bar 26 on the shaft 24 moves the flow diverting blade 22 to be moved between the first position 28 and the second position 30. In the embodiment shown in the figures, the orientation of the flow diverting blade 18 and the location of the shaft 24 relative to the first position 28 means that the flow diverting blade 18 will tend to fall into the first position 28 under gravity and the inherent weight of the flow diverting blade 18. This means that the for the abort gate 10 to allow the air system to operate and allow airflow from the flow inlet 16 through the primary outlet 18, the flow diverting blade 18 must be moved to the second position 30 and held in place.

As shown in the figures, at least one spring 32 extends between the housing 12 and the blade arming bar 26 further biases the blade arming bar 26 and the flow diverting blade 22 in their unarmed positions—i.e., with the flow diverting blade 22 in the first position 28 within the housing which diverts air flowing through the air system from the flow inlet 16 being diverted to the safe flow diversion region through the secondary outlet 20. The embodiment shown in the figures depicts three springs 32 that pull the blade arming bar 26 and hence all pull the flow diverting blade 22 into the first position 28. While the springs 32 are not needed for the flow diverting blade 22 to fall into the first position 28, as gravity alone could do so, the springs 32 greatly accelerate the movement of the flow diverting blade 22 from the second position 30 to the first position 28. This assists in the abort gate 10 being compliant with Naticonal Fire Protection Association guidelines for abort gate systems to divert air flow within 0.5 ms of the detection of hazardous conditions in the air system.

Movement of the blade diverting blade 22 may be performed manually by rotating the blade arming bar 26. Mechanical systems may also be incorporated for automatic movement of the blade arming bar 26. The figures show one such embodiment which includes a pulley system as described below. It will be understood that other systems that rotate the blade arming bar 26 are possible.

As shown in the figures, in the embodiment disclosed, a pulley bar 34 is mounted to the shaft on a set of bearings (not shown) adjacent to the blade arming bar 26. The pulley bar 34 has a pulley bar pulley 36 that receives a cable 38 that connects the pulley bar 34 to a winch 40 (discussed in more detailed below). A tab 42 on the pulley bar 34 extends towards the blade arming bar 26, such that rotation of the pulley bar 34 causes the tab 42 to push the blade arming bar 26 and also rotate the blade arming bar 26 and thereby rotate the flow diverting blade 22. At least one pulley bar spring 46 extends between the housing 12 and the pulley bar 34 to bias the pulley bar 34 towards a default position where the tab 42 is not in contact with the blade arming bar 26. This default position is indicated by a limit switch 44 and is a position where if the blade arming bar 26 were to suddenly rotate into the first position 28, it would not damage the tab 42, the pulley bar 34, or the winch 40.

The winch 40 is mounted externally on the housing 12 and is behind the cover in the figures. The winch 40 is of a kind known in the art and comprises a motor and a spool that are connected through a gear train. The cable 38 is wound around the winch 40 and extends towards a second pulley 48 which is mounted on a bracket on the outside of the housing 12. The cable 38 further wraps around the pulley bar pulley 36 and the free end of the cable 38 is then anchored 50 to the housing 12. The winch is 40 actuated by a controller board within a control box 52 which, in the embodiment shown, is mounted on the outside of the housing 12. This controller may be any microcontroller or processor that can control the speed and direction of the winch 40.

The second pulley 48 is a fixed pulley that redirects the force of the winch 40, while the pulley bar pulley 36 is a movable pulley which provides the mechanical advantage to the system. This pulley arrangement effectively halves the required force needed to move the flow diverting blade 22, enabling arming of the flow diverting blade 22 with lower power components. This gain in mechanical advantage is accompanied by an increased cable retraction distance. This configuration allows high rotational frequency to be easily achieved by common and readily available electric motors.

Because the free end of the cable 38 is secured to the housing 12, tension in the cable 38 rotates the pulley bar 34 on the shaft 24 towards the blade arming bar 26. As the pulley bar 34 rotates, the tab 42 contacts the blade arming bar, causing the blade arming bar 26 to rotate with the pulley bar 34 under the influence of the cable 28. As the winch 40 retracts the cable 38, the blade arming bar 26 is rotated towards the second pulley 48. The shaft 24 is rotated with the blade arming bar 26 until the flow diverting blade 22 reaches the armed second position 30.

As previously indicated, when the flow diverting blade 18 is be moved to the second position 30, it must be held in place for the abort gate 10 to be operable. Various systems may be incorporated within the housing to do so, including mechanical means such as latches or pins, or, as shown in the embodiments herein, electromagnets 54. The armed second position 30 is indicated by a limit switch 56 mounted within the housing 12. When the flow diverting blade 22 contacts this limit switch 56, a signal is sent to the controller. The controller then activates electromagnets 54 on the housing 12, which secure the flow diverting blade 22 in the armed second position 30. When armed and located in the second position 30, the flow diverting blade 22 seals the secondary outlet 20 to allow the flow to travel through the main duct path through the primary outlet 18 as shown in FIG. 2.

After arming of the flow diverting blade 22 is complete, the winch 40 is reversed to back the pulley bar 34 to away from the blade arming bar 26 and return to its original position under the influence of the pulley bar spring 46. The pulley bar spring 46 biases the pulley bar 34 against the limit switch 44 located at the default position on the housing 12. When the pulley bar 34 contacts the second limit switch 44, the winch 40 is deactivated by the controller. The pulley bar 34 is backed away from the blade arming bar 26 in this way to prevent damage to the winch 40, pulley bar 34, and housing 12 when the heavy flow diverting blade 22 is released and moves to the first position 28 to seal the primary outlet 18. The limit switches 44 and 56 could be replaced or augmented with proximity sensors to detect the position of the flow diverting blade 22 and the pulley bar 34.

Sensors may be mounted in the flow upstream from the flow diverting blade 22 to monitor the flow for smoke, sparks, dust, fumes, or any other hazardous material. When a hazardous material is detected by a sensor, the controller deactivates the electromagnets 54 to release the flow diverting blade 22 from the second position 22. Under the influence of gravity and the tension in the springs 32, the flow diverting blade 22 drops instantly to the first position 28 to seal the primary outlet 18 and divert the flow out through the secondary outlet 20. Re-arming of the flow diverting blade 22 can be done automatically by the controller when the flow is determined to be safe, or it may be manually initiated.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. An abort gate to divert airflow in an air system comprising:
a housing comprising a flow inlet from the air system, a primary outlet to the air system, and a secondary outlet to a safe flow diversion region;
a flow diverting blade mounted to a shaft within said housing;
a blade arming bar fixed to said shaft such that rotating said blade arming bar also rotates said flow diverting blade within said housing between a first position and a second position;
when said flow diverting blade is in said first position, said flow diverting blade seals said primary outlet and flow though said housing is diverted from said flow inlet through said secondary outlet;
when said flow diverting blade is in said second position, said flow diverting blade seals said secondary outlet and flow through said housing is diverted from said flow inlet though said primary outlet; and
a pulley bar mounted to said shaft, said pully bar is adjacent to said blade arming bar, said pulley bar comprising:
a pulley bar pulley that receives a cable that connects said pulley bar to a winch; and
a tab on said pulley bar that extends towards said blade arming bar, such that rotation of said pulley bar toward said blade arming bar causes said tab to push said blade arming bar and also rotate said blade arming bar thereby rotating said flow diverting blade.

2. The abort gate of claim 1 further comprising when said abort gate is armed said flow diverting blade is releasably fixed against said second position with one of electromagnets, latches, and pins.

3. The abort gate of claim 1 further comprising a spring mounted to said blade arming bar biases said flow diverting blade in said first position.

4. The abort gate of claim 1 further comprising said flow diverting blade is biased in said first position by gravity.

5. The abort gate of claim 1 further comprising a pulley bar spring extending between said housing and said pulley bar to bias said pulley bar away from said blade arming bar.

6. The abort gate of claim 1 further comprising sensors mounted upstream from said flow diverting blade to disarm said abort gate and release said flow diverting blade from said second position thereby allowing said flow diverting blade to move into said first position.

7. The abort gate of claim 1 further comprising the position of said flow diverting blade is determined by one of limit switches and proximity sensors.

8. The abort gate of claim 1 further comprising a limit switch located at said second position such that movement of said flow diverter gate to said second position actuates said winch to move said pulley bar such that said tab is not contact with said blade arming bar.

9. The abort gate of claim 1 further comprising said pully bar having a default position where if said blade arming bar were in said first position, that said tab is not contact with said blade arming bar.

10. The abort gate of claim 1 further comprising:
said pully bar having a default position where if said blade arming bar where in said first position, that said tab is not contact with said blade arming bar; and
a limit switch located at said default position that stops the operation of said winch when said pully bar reaches said default position.

11. The abort gate of claim 1 further comprising a second pully fixed to said housing interposed on said cable between said winch and said pulley bar pully.

12. The abort gate of claim 1 further comprising:
a second pully fixed to said housing interposed on said cable between said winch and said pulley bar pully; and
said cable running from said winch through said second pully then through said pully bar pully, and then fixed to said housing, such that actuation of said winch moves said pully bar pully and rotates said pulley bar.
